(19) United States
(12) Patent Application Publication
(10) Pub. No.: US 2018/0196165 A1
(43) Pub. Date: Jul. 12, 2018

(54) Anti-UV Mask

(71) Applicant: Zeppelin, Inc., APIA (WS)

(72) Inventor: Kuo-Ching CHIANG, New Taipei City (TW)

(21) Appl. No.: 15/494,495

(22) Filed: Apr. 22, 2017

(30) Foreign Application Priority Data
Jan. 11, 2017 (TW) 106100882

(51) Int. Cl. G02B 1/04; B32B 5/02; B01D 46/00; B01D 39/08; A62B 23/02; G02B 5/00

(52) U.S. Cl. CPC G02B 1/04; B32B 5/02; B01D 46/0027; B01D 46/0001; B01D 39/083; B01D 2239/065; G02B 5/003; B32B 2307/4026; B32B 2262/02; B01D 2275/10; A62B 23/025

(57) ABSTRACT

An anti-ultraviolet mask includes an outer layer having fiber that can absorb ultraviolet rays. The middle layer is composed of material that is capable of filtering out dust and bacteria, and an inner layer is arranged to fit the face.

### CROSS-REFERENCE TO RELATED APPLICATIONS

The present application is based on, and claims priority from, Taiwan Patent Application Serial Number 106100882, filed Jan. 11, 2017, the disclosure of which is hereby incorporated by reference herein in its entirety.

### TECHNICAL FIELD

The present invention relates to a mask, and particularly to an anti-UV mask.

### BACKGROUND OF RELATED ARTS

There are a variety of masks. The traditional mask has three-layer or four-layer configurations. Generally, a non-medical mask includes an outer layer, a filtering layer and an inner layer. The conventional outer layer only functions as a layer to cover the filtering layer. However, such traditional mask cannot resist UV radiation. Therefore, there is a need for a solution to solve the aforementioned problems.

### SUMMARY

One object of the present invention is to provide the surface material of the mask which has the capabilities to absorb ultraviolet radiation.

Another object of the present invention is to disclose a mask material which can especially absorb ultraviolet radiation and change the color of the mask to allow the absorbing effect be observable.

An UV absorbent mask includes polymeric base material doped with UV absorbent dye such as photochromic dye with a mixing ratio; the fiber is formed by melting the polymeric base material, the photochromic or thermochromic dye is added and the photochromic or thermochromic dye is distributed in the polymeric base material evenly, the drawnwork process is performed after melting process, wherein the melting temperature and the drawnwork temperature are below the dissociation temperature of the photochromic or thermochromic dye. The material of the mask includes photochromic or thermochromic dye to absorb UV radiation and achieve anti-UV function; wherein if the adjustment of the color of the base material is required, non-photochromic or non-thermochromic dye (i.e. high molecular dye) may be doped into the polymeric base material when mixing the polymeric base material and the photochromic or thermochromic dye. Such may skip the step of difficult post coloring procesure. The processing temperature should be be lower than the dissociation temperature of the photochromic or thermochromic dye. The present invention further includes adding stabilizer, antioxidant, UV absorbent or the combination thereof during melting process or drawnwork process. The mixing ratio of the base material and the photochromic dye is one to one over one hundred thousands˜one to one over ten thousand; one to one over ten thousand˜one to five over ten thousand; one to five over ten thousand˜one to one over one thousand; one to one over one thousand˜one to one over five hundreds.

The polymeric base material includes polyamide fiber, polyester fiber, polyacrylonitrile fiber, polyethylene fiber, polypropylene fiber, polyvinylalcohol fiber, polyvinylchloride fiber, polytetrafluoroethylene fiber, Nylon, poly(ethylene terephthalate)(PET), Polybutylene terephthalate (PBT), polyurethane fiber or any combination thereof. The base material may be mixed with natural fiber, semi-synthetic fiber or synthetic fiber.

A method of manufacturing UV absorbent fiber, the method characterized by including: preparing a base material for manufacturing UV absorbent fiber and preparing photochromic or thermochromic dye; mixing the base material and the photochromic or thermochromic dye by a ratio; melting the base material to render the photochromic or thermochromic dye to be distributed in the base material, wherein the melting temperature is below the dissociation temperature of the photochromic dye, wherein if the color adjustment of the base material is required, non-photochromic or non-thermochromic dye may be doped into the polymeric base material to achieve the desired color, so as to form masterbatches; the next steps are : transferring the masterbatches to the drawnwork machine and dissolving the masterbatches; performing drawnwork to the base material of the melted masterbatches to form raw material yarn to render the raw material yarn to have UV absorbent function. The present invention further includes adding stabilizer, antioxidant, UV absorbent or the combination thereof during melting process. The photochromic or thermochromic dye may be in the form of powders, microcapsules, liquid, solution or masterbatches. The mixing ratio of the base material and the photochromic or thermochromic dye is one to one over several tens of thousands˜one to one over ten thousand; one to one over ten thousand˜one to five over ten thousand; one to five over ten thousand˜one to one over one thousand; one to one over one thousand˜one to one over several hundreds.

A method of manufacturing UV absorbent fabric, the method characterized by including: preparing a base material and preparing photochromic or thermochromic dye; adding the photochromic or thermochromic dye into a solution of the base material by a ratio to dissolve the photochromic or thermochromic dye, wherein the dissolving temperature is below the dissociation temperature of the photochromic or thermochromic dye, wherein if the basic color of the base material is needed to be adjusted, non-photochromic or non-thermochromic dye may be doped into the polymeric base material to achieve the needed color; distributing the photochromic or thermochromic dye in the solution of the base material; forming the basic masterbatches by inject molding machine; transferring the basic masterbatches to the drawnwork machine to form raw material yarn.

The raw material yarn is weaved into fabric to render the fabric to have UV absorbent function. The present invention further includes adding stabilizer, antioxidant, UV absorbent or the combination thereof during melting process. The photochromic or thermochromic dye may be in the form of powders, microcapsules, liquid, solution or masterbatches. The mixing ratio of the base material and the photochromic or thermochromic dye is one to one over several tens of thousands˜one to one over ten thousand; one to one over ten thousand one to five over ten thousand; one to five over ten thousand˜one to one over one thousand; one to one over one thousand˜one to one over several hundreds. The polymeric base material includes polyamide fiber, polyester fiber, polyacrylonitrile fiber, polyethylene fiber, polypropylene fiber, polyvinylalcohol fiber, polyvinylchloride fiber, polytetrafluoroethylene fiber, Nylon, poly(ethylene terephthalate)(PET), Polybutylene terephthalate (PBT), polyurethane fiber or any combination thereof. The base material may be mixed with natural fiber, semi-synthetic fiber or synthetic fiber.

A UV absorbent composition, the base material of which is polymer. The photochromic or thermochromic dye is mixed therein. The polymer and the photochromic or thermochromic dye are processed and mixed under the temperature which is below the dissociation temperature of the photochromic or thermochromic dye. The photochromic composition is formed by molding device. The mixing ratio of the base material and the photochromic or thermochromic dye is one to one over several tens of thousands˜one to one over ten thousand; one to one over ten thousand˜one to five over ten thousand; one to five over ten thousand˜one to one over one thousand; one to one over one thousand˜one to one over several hundreds; one to one over several hundreds˜one to one over several tens. If the polymeric base material includes polyester, the processing temperature is 200-250 degree Celsius. If the polymeric base material includes polypropylene, the processing temperature is 140-180 degree Celsius. The base material may be mixed with natural fiber, semi-synthetic fiber or synthetic fiber.

An anti-ultraviolet mask, the mask at least including: an outer layer including ultraviolet absorbent fiber, wherein the fiber includes ultraviolet absorbent dye added into polymeric material; a middle layer made of material which can filter out dusts or bacteria; an inner layer arranged to fit the face, wherein the middle layer is located between the inner layer and the outer layer. The present invention further includes adding stabilizer, antioxidant, UV absorbent or the combination thereof during melting process or drawnwork process. The drawnwork temperature is below the dissociation temperature of the UV absorbent dye. The mixing ratio of the base material and the UV absorbent dye is one to one over several tens of thousands˜one to one over ten thousand; one to one over ten thousand˜one to five over ten thousand; one to five over ten thousand˜one to one over one thousand; one to one over one thousand˜one to one over several hundreds. The polymeric material includes polyamide fiber, polyester fiber, polyacrylonitrile fiber, polyethylene fiber, polypropylene fiber, polyvinylalcohol fiber, polyvinylchloride fiber, polytetrafluoroethylene fiber, Nylon, poly(ethylene terephthalate)(PET), Polybutylene terephthalate (PBT), polyurethane fiber or any combination thereof. The polymeric material may be mixed with natural fiber, semi-synthetic fiber or synthetic fiber.

An anti-ultraviolet mask at least includes: an outer layer including anti-ultraviolet material coated on a base material of the outer layer by spray, wherein the anti-ultraviolet material includes photochromic dye; a middle layer made of material which can filter out dusts or bacteria; an inner layer arranged to fit a face, wherein the middle layer is located between the inner layer and the outer layer. The base material includes polyamide fiber, polyester fiber, polyacrylonitrile fiber, polyethylene fiber, polypropylene fiber, polyvinylalcohol fiber, polyvinylchloride fiber, polytetrafluoroethylene fiber, Nylon, poly(ethylene terephthalate)(PET), Polybutylene terephthalate (PBT), polyurethane fiber or any combination thereof. The base material may be mixed with natural fiber, semi-synthetic fiber or synthetic fiber.

An anti-ultraviolet mask at least includes: an outer layer including anti-ultraviolet material coated on a base material of the outer layer by spray, wherein the anti-ultraviolet material includes ultraviolet absorbent; a middle layer made of material which can filter out dusts or bacteria; an inner layer arranged to fit a face, wherein the middle layer is located between the inner layer and the outer layer. The base material includes polyamide fiber, polyester fiber, polyacrylonitrile fiber, polyethylene fiber, polypropylene fiber, polyvinylalcohol fiber, polyvinylchloride fiber, polytetrafluoroethylene fiber, Nylon, poly(ethylene terephthalate)(PET), Polybutylene terephthalate (PBT), polyurethane fiber or any combination thereof. The base material may be mixed with natural fiber, semi-synthetic fiber or synthetic fiber.

### BRIEF DESCRIPTION OF THE DRAWINGS

For a better understanding of the present invention and to show how it may be implemented, reference will now be made to the following drawings:

FIG. 1 is a diagram of one embodiment of the present invention.

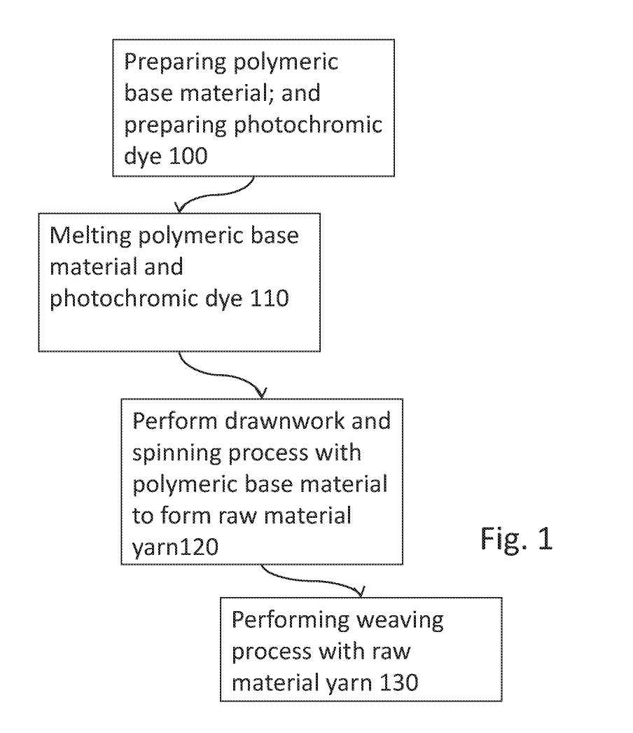

FIG. 2 is a diagram of one embodiment of the present invention.

### DETAILED DESCRIPTION

The present invention will now be described with the preferred embodiments and aspects and these descriptions interpret structure and procedures of the present invention only for illustrating but not for limiting the Claims of the present invention. Therefore, except the preferred embodiments in the specification, the present invention may also be widely used in other embodiments.

The anti-UV absorbent material or photochromic dye is coated by spray on the fabric surface of the anti-UV mask to achieve the anti-UV function. If the anti-UV absorbent material or photochromic dye is sprayed on the surface, the color change of the mask may be observed, thereby indicating the function of anti-UV. The traditional mask is not available to offer the anti-UV function, let alone observing the protective effect thereof. Actually, the traditional mask fails to provide any protection and thus is disadvantageous to the care after facial cosmetic surgery. The prevention from UV radiation is the most important procedure for the care after cosmetic surgery. Therefore, the present invention offers advantages of the skin care after cosmetic surgery. The traditional mask cannot achieve the aforementioned function at all.

The present invention dopes the photochromic dye with the high molecular polymer, and may mix the photochromic dye and the high molecular polymer in the form of micro powders or microcapsules. The manufacturing method may coat the anti-UV material or photochromic dye onto the surface of the mask fabric. It is unlikely to decade the ability of the present anti-UV mask due to the present invention dopes and immerses the photochromic dye into the polymer before the drawnwork process. However, if under the convenience and the manufacture cost consideration, spray coating may be utilized. The photochromic dye may absorb sunlight or ultraviolet radiation, and the chemical structure of the photochromic dye is changed after receiving the radiation, therefore, the color transition phenomenon occurs in the medium such as high molecular polymer. The method includes melting the polymer by raising the temperature or dissolving the photochromic dye in polymer solution to distribute the photochromic dye in the polymer solution substantially evenly. Furthermore, during this stage, dye or color masterbatch may be added into polymer by demand for color adjustment. Adding dye or color masterbatch in this stage can render the dye to be evenly distributed in the entirely spun fabric fiber so as to enhance the stability of the color, rather than coloring the outer surface of the fiber when spun.

The photochromic dye in the fiber can generate reversible chemical change, and thereby resulting in change of color after illuminated by the sunlight or UV radiation. When the fiber is not illuminated by the sunlight or UV light, the color of the fiber changes back to the original color. The photochromic dye may be optionally doped in the high molecular polymer together with light stabilizer and UV absorber to enhance the performance of absorbing UV radiation. Adding antioxidant or/and UV absorber into the high molecular polymer can enhance the anti-light fatigue. The photochromic dye may be spiropyrans, spiroxazines, fulgide, fulgimides, benzopyran, naphthopyran, spirobenzopyran, spironaphthopyran, spirobenzoxazine or spironaphthoxazine.

Fiber typically include natural fiber or artificial fiber. The natural fiber may be, for example, plants fiber such as cotton, kapok; linen, jute, hemp, ramie fiber, etc; leaf fiber: manila hemp, sisal, new zealand hemp, piña, etc; fruit fiber: coir. Animal fiber may include wool & hair fiber: sheep wool, camel wool, alpaca, cashmere hair, mohair hair, goat hair, etc; silk: cultivated silk, tussah silk; mineral fiber: asbestos.

The artificial fiber may include (1) regenerated fiber: such as inorganic regenerated fiber: glass fiber, metal fiber, rock fiber, slag fiber, etc. Organic regenerated fiber may include for instance protein fiber: casein fiber, groundnut fiber, soybean fiber, maize fiber, PLA fiber, etc; cellulose fiber: viscose rayon, cuprammonium rayon, lyocell; chitin fiber, etc.

(2) Semi synthetic fiber: such as acetate fiber or triacetate fiber.

(3) Synthetic fiber is monomer raw material obtained from nature and forms fiber by polymerization and fiber spinning. For example, condensation polymer: (A) polyamide fiber: Nylon 6, Nylon 6.6, Nylon 11; (B) polyester fiber: PET, PBT, PTT; (C) addition polymer: (1) polyacrylonitrile fiber: PAN (also referred to as acrylic fiber); (2) polyethylene fiber: PE; (3) polypropylene fiber: PP; (4) polyvinylalcohol fiber: PVA; (5) polyvinylchloride fiber: PVC; (6) polytetrafluoroethylene fiber: PTFE; (7) polyurethane fiber: PU. Carbon fiber and glass fiber are classified as inorganic synthetic fiber. High functional fiber may include poly lactic acid, PBO fiber (p-phenylene-2,6-benzobisoxazole), high-tenacity polyester, polyamide, polyolefine, p-aromatic polyamide and meta-aromatic polyamide, carbon fiber, high-modulus polyethylene (HMPE), polyphenylene sulfide (PPS), phenlic fiber of polymer, polyether ether ketone (PEEK), P84, etc. If polypropylene fiber is employed, grafted polypropylene fiber is preferred to render it to be dyed after being mixed with other material. Moreover, traditional color unchangeable dye and color changeable dye are added into plastics such as polypropylene and are processed at temperature of 140 degree Celsius to 180 degree Celsius when preparing base masterbatches.

Take synthetic fiber as an example. Firstly, in step 100, high molecular or polymeric base material and photochromic dye are prepared (if thermochromic dye is utilized, the energy generated by UV radiation is absorbed and color change phenomena occur). If the mask color is necessary to be adjusted, the traditional dye (non-photochromic) or color masterbatch may be prepared. Photochromic dye or thermochromic dye may be employed, or color changeable molecules may be added into the polymers or resin material. The base material and the photochromic dye before fiber drawnwork may be in the form of powders, capsules, liquid, solution or plastic masterbatches. The mixing ratio of photochromic dye and polymer may be about 0.01%˜0.5% weight percentage (w/w); or 0.5%˜0.1% or 0.1%˜1.5%. Subsequently, in step 110, the high molecular or polymeric base material and photochromic dye may be stirred and mixed evenly, and be heated to melt the high molecular or polymeric base material, so as to fusion the high molecular or polymeric base material with the photochromic dye. The heating and fusioning temperature needs to be below the dissociation temperature of the photochromic dye. The mixing ratio between the photochromic dye and the high molecular polymer and the mixing concentration of the photochromic dye are both related to the color change effect. Based on the powdered photochromic dye and the choice of the processing temperature, dispersing agent may be not necessary. For example, the process temperature may be 150-180 degree or 180-220 degree. Because the embodiment may be performed in the form of powders, capsules, liquid, solution and drawnwork may be implemented in situ, it is not necessary to form masterbatches. However, masterbatches are advantageous to ex situ processing and convenience of transporting. Therefore, the high molecular masterbatches may be formed from the mixed material before drawnwork.

The present invention discloses a photochromic composition, which employs the polymer that performs the role of fiber base material, the base material is doped with photochromic dye, and the base material is heated and melted, the photochromic dye is dissolved in the base material, where the processing temperature during mixing is below the dissociation temperature of the photochromic dye. The plastics may be dried for 1 to 5 hours depending upon the amount and the material thereof before the manufacturing process. Then, the high molecular polymer and the photochromic dye are mixed and processed, subsequently. The mixing ratio thereof may be different according to different usage. The ratio of the photochromic dye may be one over several tens of thousands to one over ten thousand; one over ten thousand to five over ten thousand; five over ten thousand to one over one thousand; one over one thousand to one over several hundreds, or one over several hundreds to one over several tens. Based on the aforementioned, after the plastics are dried and mixed with the photochromic material, the mixture is loaded into the drawnwork device with even stirring. Different temperatures and different concentrations will affect the color of the basic color, such that the temperature and the concentration are the primary facts for achieving the desired color. Furthermore, the heating, the mixing and the drawnwork processes are performed under the processing temperature which needs to be lower than the dissociation temperature of the photochromic dye to form the raw material yarn. Therefore, the temperature may be adjusted to cooperate with different photochromic material. The photochromic material generates thermal change after illuminated by the sunlight or UV radiation. When it is not exposed by the sunlight or the UV radiation, the color of the photochromic material will change back to the original color. The photochromic dye absorbs the sunlight or UV radiation to cause the chemical structure transition which results in color change. Thus, the photochromic dye may cause the color of the fiber to change in addition to absorbing UV radiation, so as to express the fashion style, and also render the anti-UV effect to be observable. Antioxidant or/and UV absorbent may be added to improve the anti-light fatigue.

The photochromic dye or the thermochromic dye and the base polymeric or high molecular material may be mixed evenly to form masterbatches. In step 120, when performing drawnwork process, the mixed polymeric base material may be melted to perform drawnwork process. Regardless of natural fiber, semi-synthetic fiber or synthetic fiber, the drawnwork techniques and the manufacturing processes thereof are well-known and the processing steps before and after drawnwork may be understood by the person having ordinary skill in the art. Thus, the drawnwork techniques and the manufacturing processes of natural fiber, semi-synthetic fiber or synthetic fiber and the processing steps before and after drawnwork are omitted in order not to obscure the present invention.

After finishing the drawnwork process, the raw material yarn may be obtained to form various kinds of fabrics 130 by weaving, plain weaving or knitting. At this time, the fabrics are referred to as greige. A variety of other processes such as dyeing, embossing or patterning may be understood by the person having ordinary skill in the art and therefore are omitted.

The fusion process for the polymer may be as follows. For instance, the melt spinning method: the photochromic material or color changeable material and the polymeric base material is melted and spun. Alternatively, the photochromic material may be distributed in the resin carrier which is capable of mixing with and melting with spinning polymer, and the mixture may be mixed with polymer such as polyester, nylon, polypropylene to perform melt spinning. In another embodiment, solution spinning method may also be employed to add the photochromic material and anti-transfer assistant into polymeric material solution directly to be dissolved, and the mixture may be spun to obtain photochromic fiber. Compared with melt spinning, the spinning temperature of such method is lower and oxidation or thermal dissociation will not happen. In another embodiment, the photochromic material or color changeable material may be dissolved in appropriate solvent, and then the mixture may be mixed with the adhesive such as polymer or resin liquid to form photochromic material slurry. The fiber or textile may be coated with such slurry to obtain color changeable fiber. Such method performs drawnwork firstly and then implements dip dyeing and coating with photochromic slurry. Composite spinning method takes the photochromic material as a core and the common fiber as a sheath to perform eutectic spinning, so as to acquire sheath-core composite fiber.

An example of solution spinning method is provided as follows, but the present invention is not limited to the following method and base material which are illustrated only as an example. For example, cellulose acetate, acrylonitrile polymer and solvent are prepared to form spinning raw material solution. The solvent, for example inorganic acid or inorganic salt, may dissolve the cellulose acetate and acrylonitrile polymer. Such solvent should be appreciated by the person having ordinary skill in the art. The spinning raw material solution is mixed and stirred and is doped with photochromic dye at the same time to form spinning raw material solution. End-drawn yarn with fiber pattern may be formed by employing the spinning raw material solution as the raw material and utilizing well-known spinning nozzle. Subsequently, the end-drawn yarn may be drawn to multiple times longer than the original length. Dry drawnwork may also be utilized and should be appreciated by the person having ordinary skill in the art. Therefore, the related description thereof is omitted.

The original manufacturing processes will not be changed and additional operation is unnecessary by employing the aforementioned method. The photochromic dye or thermochromic dye is added into and mixed with the plastics before drawnwork to render the photochromic dye or thermochromic dye to be fusioned with the high molecular polymer and be distributed in the polymeric material evenly. Then, the drawn fibers have photochromic dye which is evenly distributed therein and forms a portion of the fibers. Alternatively, the drawn fibers are mixed with the slurry after drawnwork. An alternative method is to fusion during spinning process. Composite spinning method takes the photochromic material as a core and the common fiber as a sheath to perform eutectic spinning, so as to acquire sheath-core composite fiber. Such method preferably dopes the resin carrier with the photochromic dye as the drawnwork material. In other embodiments, raw material, for example polymer, such as polyester fiber, polyamide fiber, polyvinyl alcohol fiber, polypropylene fiber, may be mixed with natural fiber such as cotton, hair, silk, hemp.

Another embodiment of the present invention is to coat with UV absorbent or photochromic dye to render it to generate chemical transition or change, and thereby causing the effect of color change. Not only the UV radiation is absorbed, but also the anti-UV function is observable because of the change of the color, such that consumers' trust will be enhanced. Moreover, PET bottles may be recycled to serve as the polymeric material described above to achieve the effect of the environmental protection. Furthermore, the processing temperature of the present invention is required to be lower than the dissociation temperature of the photochromic dye; masterbatches or traditional plastic dye may be added when doping the polymer with UV absorbent dye, so as to render the UV absorbent dye to be distributed in the high molecular base material evenly.

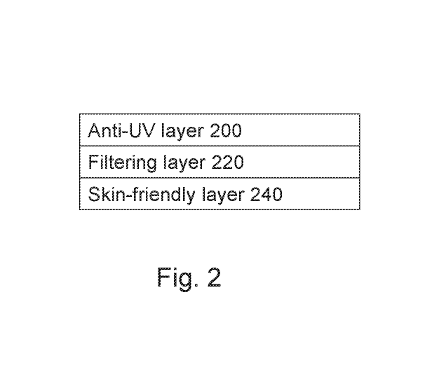

Therefore, please refer to FIG. 2, which illustrates a cross-sectional diagram of the mask of the present invention. The mask of the present invention may include three layers or four layers or more. This embodiment takes three layers as an example. The outer layer is an anti-ultraviolet layer 200, the manufacturing method of which may refer to the aforementioned methods, and the fiber of the outer layer is coated with anti-ultraviolet material or dye by spray. Alternatively, the outer layer is formed with fabric with color changeable fiber. The middle layer may be a filtering layer 220 to filter out dusts, bacteria, etc. The inner layer 240 may be made of cotton fabric, and may also be made of skin-friendly material such as bombasine or TPE, etc.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the present invention. It is intended that all such modifications and alterations are included insofar as they come within the scope of the present invention as claimed or the equivalents thereof.

1. A mask comprising:
an outer layer including ultraviolet absorbent fiber having ultraviolet absorbent dye added into polymeric material;
a middle layer made of material which filters out dusts or bacteria;
an inner layer arranged to fit a face, wherein said middle layer is located between said inner layer and said outer layer.

2. The mask of claim 1, wherein said ultraviolet absorbent fiber includes stabilizer, antioxidant, UV absorbent or the combination thereof.

3. The mask of claim 2, wherein a temperature of a fiber drawnwork process is below a dissociation temperature of said ultraviolet absorbent dye.

4. The mask of claim 3, wherein a mixing ratio of said polymeric material and said ultraviolet absorbent dye is one to one over several tens of thousands˜one to one over ten thousand; one to one over ten thousand˜one to five over ten thousand; one to five over ten thousand˜one to one over one thousand; one to one over one thousand˜one to one over several hundreds.

5. The mask of claim 3, wherein said polymeric material includes polyamide fiber, polyester fiber, polyacrylonitrile fiber, polyethylene fiber, polypropylene fiber, polyvinylalcohol fiber, polyvinylchloride fiber, polytetrafluoroethylene fiber, Nylon, poly(ethylene terephthalate)(PET), Polybutylene terephthalate (PBT), polyurethane fiber or any combination thereof.

6. The mask of claim 5, wherein said polymeric material is mixed with natural fiber, semi-synthetic fiber or synthetic fiber.

7. The mask of claim 2, wherein a mixing ratio of said polymeric material and said ultraviolet absorbent dye is one to one over several tens of thousands˜one to one over ten thousand; one to one over ten thousand˜one to five over ten thousand; one to five over ten thousand˜one to one over one thousand; one to one over one thousand˜one to one over several hundreds.

8. The mask of claim 2, wherein said polymeric material includes polyamide fiber, polyester fiber, polyacrylonitrile fiber, polyethylene fiber, polypropylene fiber, polyvinylalcohol fiber, polyvinylchloride fiber, polytetrafluoroethylene fiber, Nylon, poly(ethylene terephthalate)(PET), Polybutylene terephthalate (PBT), polyurethane fiber or any combination thereof.

9. The mask of claim 8, wherein said polymeric material is mixed with natural fiber, semi-synthetic fiber or synthetic fiber.

10. The mask of claim 1, wherein a mixing ratio of said polymeric material and said ultraviolet absorbent dye is one to one over several tens of thousands˜one to one over ten thousand; one to one over ten thousand˜one to five over ten thousand; one to five over ten thousand˜one to one over one thousand; one to one over one thousand˜one to one over several hundreds.

11. The mask of claim 1, wherein said polymeric material includes polyamide fiber, polyester fiber, polyacrylonitrile fiber, polyethylene fiber, polypropylene fiber, polyvinylalcohol fiber, polyvinylchloride fiber, polytetrafluoroethylene fiber, Nylon, poly(ethylene terephthalate)(PET), Polybutylene terephthalate (PBT), polyurethane fiber or any combination thereof.

12. The mask of claim 11, wherein said polymeric material is mixed with natural fiber, semi-synthetic fiber or synthetic fiber.

13. A mask comprising:
an outer layer including anti-ultraviolet material coated on a base material of said outer layer, wherein said anti-ultraviolet material includes photochromic dye mixed with polymer;
a middle layer made of material which can filter out dusts or bacteria;
an inner layer arranged to fit a face, wherein said middle layer is located between said inner layer and said outer layer.

14. The mask of claim 13, wherein said base material includes polyamide fiber, polyester fiber, polyacrylonitrile fiber, polyethylene fiber, polypropylene fiber, polyvinylalcohol fiber, polyvinylchloride fiber, polytetrafluoroethylene fiber, Nylon, poly(ethylene terephthalate)(PET), Polybutylene terephthalate (PBT), polyurethane fiber or any combination thereof.

15. The mask of claim 14, wherein said base material is mixed with natural fiber, semi-synthetic fiber or synthetic fiber.

16. A mask comprising:
an outer layer including anti-ultraviolet material coated on a base material of said outer layer, wherein said anti-ultraviolet material includes ultraviolet absorbent mixed with polymer;
a middle layer made of material which can filter out dusts or bacteria;
an inner layer arranged to fit a face, wherein said middle layer is located between said inner layer and said outer layer.

17. The mask of claim 16, wherein said base material includes polyamide fiber, polyester fiber, polyacrylonitrile fiber, polyethylene fiber, polypropylene fiber, polyvinylalcohol fiber, polyvinylchloride fiber, polytetrafluoroethylene fiber, Nylon, poly(ethylene terephthalate)(PET), Polybutylene terephthalate (PBT), polyurethane fiber or any combination thereof.

18. The mask of claim 16, wherein said base material is mixed with natural fiber, semi-synthetic fiber or synthetic fiber.
